(19) United States
(12) Patent Application Publication
(10) Pub. No.: US 2026/0160631 A1
(43) Pub. Date: Jun. 11, 2026

(54) SYSTEMS AND METHODS FOR CENTER OF GRAVITY CONTROL OF A DEVICE

(71) Applicants: University of Cincinnati, Cincinnati, OH (US); Gimbal Innovations, Inc., Mason, OH (US)

(72) Inventors: Donghoon Kim, Mason, OH (US); Daegyun Choi, Cincinnati, OH (US); Daniel P. O'Reilly, Mason, OH (US)

(73) Assignees: University of Cincinnati, Cincinnati, OH (US); Gimbal Innovations, Inc., Mason, OH (US)

(21) Appl. No.: 19/129,153

(22) PCT Filed: Nov. 14, 2023
(86) PCT No.: PCT/US2023/079571

§ 371 Date: May 12, 2025

Related U.S. Application Data
(60) Provisional application No. 63/425,123, filed on Nov. 14, 2022.

(51) Int. Cl. G01M 1/12; G09B 9/12

(52) U.S. Cl. CPC G01M 1/122; G09B 9/12

(57) ABSTRACT

Systems and methods for controlling a center of gravity (CoG) of a device include one or more weights mechanically coupled to the device and operable to move along one or more body axes of the device, one or more motion sensors configured to determine state information of the device, and one or more processors. The processors are operable to determine that the device is occupied by a user, estimate the CoG of the device based on the state information of the device, determine a CoG deviation based on the CoG of the device and a target CoG, and move the weights to reduce the CoG deviation to less than or equal to a threshold CoG deviation.

### CROSS REFERENCE TO RELATED APPLICATION

This application claims priority to U.S. Provisional Application Ser. No. 63/425,123, filed Nov. 14, 2022, the entire contents of which are incorporated herein by reference.

### TECHNICAL FIELD

The present disclosure relates to active control systems, and more particularly, to active control systems for device stability.

### BACKGROUND

The stability and control characteristics of devices and equipment can vary when the devices or equipment are in motion or when objects and people are being loaded to or unloaded from the devices or equipment. Ensuring stability is a critical factor in maintaining the performance of these devices and equipment. Consequently, there is a demand for a system that can actively manipulate the center of gravity of these devices and equipment to provide desirable control.

### SUMMARY

In a first aspect, a system for controlling a Center of Gravity (CoG) of a device includes one or more weights mechanically coupled to the device and operable to move along one or more body axes of the device, one or more motion sensors configured to determine state information of the device, and one or more processor. The processors are operable to determine that the device is occupied by a user, estimate the CoG of the device based on the state information of the device, determine a CoG deviation based on the CoG of the device and a target CoG, and move the weights to reduce the CoG deviation to less than or equal to a threshold CoG deviation.

In a second aspect, a simulator includes a simulator pillar having a base end and a rotation point end, a simulator body rotatably coupled to the pillar at the rotation point end, the simulator body configured to be occupied by a user, a simulator base mechanically coupled to the pillar at the base end, one or more actuators configured to move the simulator body to generate a control torque of the simulator, wherein the actuators comprises one or more of gimbals, flywheels, or a combination thereof mechanically attached to the simulator body and operably generating control torque to substantially compensate for a torque of the simulator body by adjusting angular velocities of the gimbals or magnitudes of angular momentum of the flywheels, one or more weights mechanically coupled to the simulator and operable to move along one or more body axes of the simulator, one or more motion sensors configured to determine state information of the simulator, wherein the motion sensors include one or more of accelerometers, gyroscopes, magnetometers, an Inertial Measurement Unit (IMU), or a combination thereof, and one or more processor. The processors are operable to determine that the simulator is occupied by the user, estimate the CoG of the simulator based on the state information of the simulator, determine a CoG deviation based on the CoG of the simulator and a target CoG, wherein the target CoG is a CoG of the simulator body without occupancy by the user, a rotation center of the simulator, or a point around the rotation center to generate an assistant torque, and move the weights to reduce the CoG deviation to less than or equal to a threshold CoG deviation.

In a third aspect, a method for controlling a CoG of a device include determining that the device is occupied by a user, estimating the CoG of the device based on state information of the device determined by one or more motion sensors, determining a CoG deviation based on the CoG of the device and a target CoG, wherein the target CoG is a CoG of the device not occupied by the user, a rotation center of the device, or a point around the rotation center to generate an assistant torque, and moving one or more weights to reduce the CoG deviation to less than or equal to a threshold CoG deviation, wherein the one or more weights are mechanically coupled to the device and operable to move along one or more body axes of the device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an exemplary system for Center of Gravity (CoG) control of a device of the present disclosure, according to one or more embodiments shown and described herein;

FIG. 2 schematically depicts exemplary non-limiting components of a controller of the present disclosure, according to one or more embodiments shown and described herein;

FIG. 3A schematically depicts a CoG of an example unoccupied device of the present disclosure, according to one or more embodiments shown and described herein;

FIG. 3B schematically depicts a CoG of an example occupied device of the present disclosure, according to one or more embodiments shown and described herein;

FIG. 4A schematically depicts a CoG of an example occupied device before a CoG adjustment of the present disclosure, according to one or more embodiments shown and described herein;

FIG. 4B schematically depicts a CoG of an example occupied device after a CoG adjustment of the present disclosure, according to one or more embodiments shown and described herein;

FIG. 5 illustrates a flow diagram of the pre-operation process using the CoG control system of the present disclosure, according to one or more embodiments shown and described herein;

FIG. 6 illustrates a flow diagram of an initial CoG determination process using the CoG control system of the present disclosure, according to one or more embodiments shown and described herein;

FIG. 7 illustrates a flow diagram of dynamic CoG adjustment using the CoG control system of the present disclosure, according to one or more embodiments shown and described herein;

FIG. 8 illustrates a flow diagram of the retraining process using the CoG control system of the present disclosure, according to one or more embodiments shown and described herein; and

FIG. 9 illustrates a flow diagram of the method for CoG control of the present disclosure, according to one or more embodiments shown and described herein.

### DETAILED DESCRIPTION

The present disclosure involves systems and methods for controlling the Center of Gravity (CoG) of a device. The disclosed CoG control systems and methods enable devices and simulators to compensate for undesired rotational motions and increase the stability and controllability of the devices and the simulators. In some embodiments, the system may adjust the CoG of the device to create an assist torque to fully or partially compensate for a detected undesirable torque of the device. In some embodiments, the system may align the CoG of the device to the rotation center by moving one or more weights. The system may continuously estimate and adjust the CoG to the rotation center. In some embodiments, the system may lower the CoG of the device or adjust the CoG to the geometric center of the device to enhance the controllability and stability of the device.

Gimbals and Control Moment Gyroscopes (CMGs) are mechanical devices used to stabilize the orientation of an object. While gimbals are effective in reducing unwanted movement and stabilizing devices, they have certain limitations. For example, a cluster of CMGs may enter a singularity state when two of the three rotational axes of a gimbal align in such a way that it limits the cluster of CMGs's ability to control movement effectively. A cluster of CMGs in a singularity state may lose control. Further, gimbals are designed with a finite range of motion, which may not cover all possible angles and orientations. CMGs have a limited torque capacity for the equipment they are stabilizing. The disclosed methods and systems may predict and reduce the undesirable torque that is beyond the control limitation of the CMGs such that the stability of the device may be enhanced. Adjusting the CoG of a device around the pivot point or rotation point to create the assistant torque ensures that the CMGs is working in a target configuration. With the assistant torque, the load on the gimbal motors is reduced to counteract the device's movements, leading to more efficient and smoother stabilization. When the system detects that the cluster of CMGs may be about to encounter a singularity state, the system may manipulate the CoG by moving the mass to create an assist torque to prevent the singularity state. The systems and methods may also include aligning the CoG to the rotation center of the device to improve usage of CMGs, reduce power consumption, or safeguard the gimbal against excessive wear and overuse.

Throughout the disclosure, the Center of Gravity (CoG) refers to a point of an object where the weighted relative position of the distributed mass of the object sums to zero.

Various embodiments of the methods and systems for clinical procedure training are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

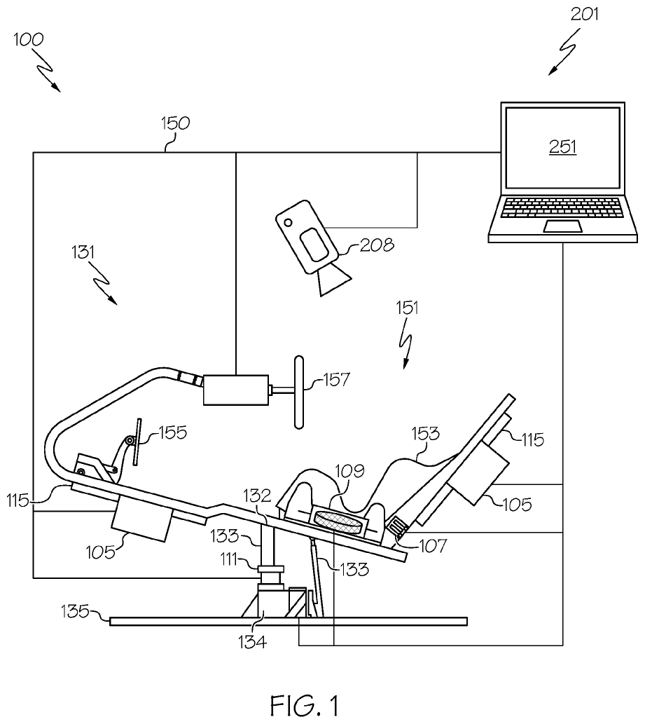

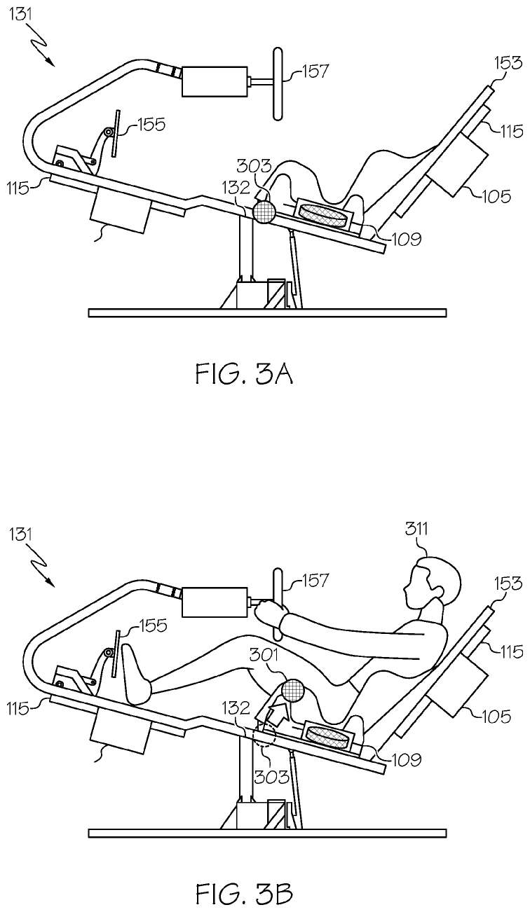

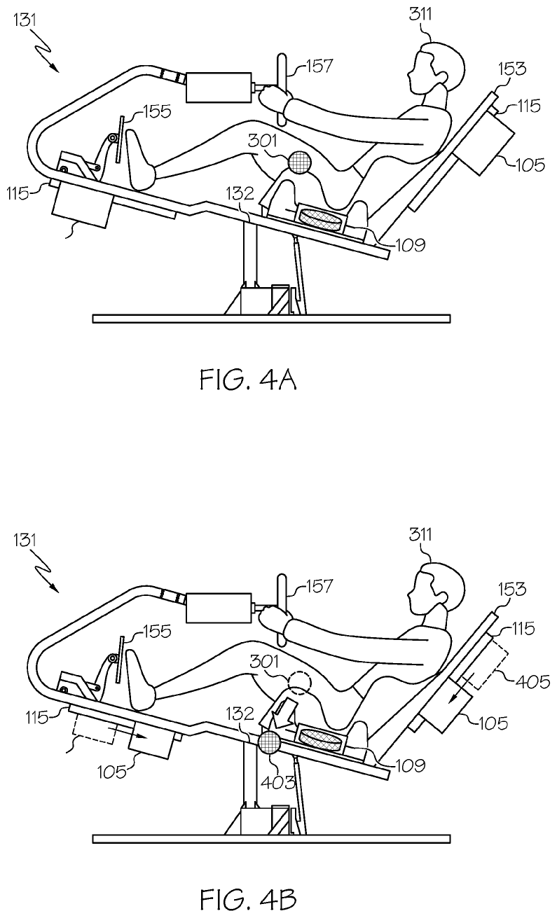

Turning to the figures, FIG. 1 schematically depicts a CoG control system 100 for a device 131 of the present disclosure. The device 131 may be occupied by a user 311 (as illustrated in FIGS. 3B-4B) through physical contact or interaction. The CoG control system 100 may include one or more weights 105, one or more tracks 115, one or more motion sensors 107, a weight sensor 111, a camera 208, one or more actuators 109, and a controller 201 having a user interface 251. The one or more actuators 109 may include one or more gimbals and one or more flywheels. The components of the CoG control system 100 may communicate with the controller 201 through connections 150. The connections 150 may be wired or wireless.

The device 131 may be, without limitation, a simulator (e.g. a vehicle simulator, a flight simulator, etc.), furniture, chair, recliner, hammock, bed, or any device that a user 311 may sit, lean on, lie on, or physically contact or interact with. In some embodiments, the device 131 may be a vehicle, a bus, a plane, or any transportation used to carry humans, animals, or goods. The device 131 may include a simulator body 151, one or more simulator pillars 133, and a simulator base 135. Each simulator pillar 133 may include a rotation point end 132 and a base end 134. The rotation point end 132 may be mechanically coupled to the simulator body 151. The rotation point end 132 may serve as a fulcrum end or a pivot point to allow the simulator body 151 to rotate, move, or tilt back and forth around the rotation point end 132. The base end 134 may be mechanically attached to the simulator base 135 such that the device 131 is securely resting on the simulator base 135. The simulator body 151 may include a simulator seat 153, a simulator foot panel 155, a simulator wheel 157, and a simulator joystick (not shown) for simulation purposes, such as simulating the experience of driving a vehicle or a plane. A separate display or interface (not shown) may be used to provide a simulation experience during an operation of the simulator by the user 311.

The CoG control system 100 may further include a controller 201 having a user interface 251 and connections 150. The connections 150 connect components of the CoG control system 100 and allow signal transmission between the components of the CoG control system 100 and the device 131. For example, the connections 150 may connect the device 131, the various sensors of the CoG control system 100, the actuator 109, the weights 105, and the camera 208. The connections 150 may be formed from any medium that is capable of transmitting a signal such as, for example, conductive wires, conductive traces, optical waveguides, or the like. In some embodiments, the connections 150 may facilitate the transmission of wireless signals, such as WiFi, Bluetooth®, Near Field Communication (NFC), and the like.

The CoG control system 100 may include one or more cameras 208. The camera 208 may be operable to acquire image and video data of the device 131 and the user 311. The acquired images and videos may be used to determine user information of the user 311, such as identification, height, dimensional information, and user movements. The acquired images and videos may also be used to determine the motion of the device 131, such as rotation. The camera 208 may be, without limitations, an RGB camera, a depth camera, an infrared camera, a wide-angle camera, or a stereoscopic camera. The camera 208 may be equipped, without limitations, on a smartphone, a tablet, a computer, a laptop, or an Augmented Reality (AR) device. The CoG control system 100 may include one or more displays. The displays may be equipped, without limitations, on a smartphone, a tablet, a computer, a laptop, or a virtual head unit, such as augmented reality glasses.

The CoG control system 100 may include the user interface 251. The user interface 251 may include a tangible object, wherein the tangible object is a marker, a physical model, a sensor, a wearable motion-tracking device, or a smartphone. The user interface 251 may be, without limitations, a keyboard, a touchpad, a joystick, a voice control module in mobile phones, wrist bands that may include electromyographic electrodes that can record hand gestures, and/or devices including electroencephalogram (EEG) electrodes to detect human intentions such as brain waves. For example, a keyboard allows users 311 to input text and commands through physical or virtual keys. A touchpad may include a touch-sensitive surface that allows users 311 to interact with system 100 and the device 131 by tapping, swiping, and performing various gestures. A joystick, such as the simulator wheel 157 or the simulator foot panel 155, may include a physical control mechanism that enables users 311 to manipulate the actuator 109 to provide control torque to the device 131 and cause the device 131 to move or rotate.

The CoG control system 100 may include the one or more weights 105 and the one or more tracks 115 coupled to the device 131. In embodiments, as illustrated in FIGS. 1, 4A-5B, the tracks 115 may be mechanically attached to the simulator body 151 along different body axes of the simulator body 151, such as a height direction, a length direction, and a width direction. The weights 105 may be mechanically coupled to the tracks 115 to move along the tracks 115 such that the CoG control system 100 may coordinate and move the weights 105 along one or more axes of the device 131 to manipulate the CoG of the device 131. The CoG control system 100 and the device 131 may be operated with wired or wireless power supplies. In some embodiments, the weights 105 may be the power suppliers, such as batteries, supercapacitors, fuel cells, and other available power suppliers, for driving the weights and the actuator 109.

The CoG control system 100 may include one or more actuators 109. The actuators 109 may provide motion energy to the device 131. In some embodiments, the actuators 109 may control the torque of the device 131 and drive the device 131 to induce rotation of the simulator body 151 at the rotation point end 132.

In embodiments, the actuators 109 may include one or more of gimbals, flywheels, or a combination thereof. In some embodiments, the actuators may be reaction wheels (RWs) or control moment gyroscopes (CMGs). The actuator 109 may include one or more of flywheels and gimbals such that a cluster of the CMGs may produce the control torque by controlling the velocities and directions of angular momentum of gimbals. The actuators 109 may include one or more of flywheels such that a cluster of the RWs may generate the control torque by changing the magnitudes of angular momentum (e.g. proportional to the rotational speed) of the flywheels. The actuators 109 may generate control torque to change the attitude, angular velocity, and/or angular acceleration of the device 131. The control torque can be produced by changing the angular momentum magnitude, direction, or combination thereof. The angular momentum magnitude can be changed by adjusting the rotational speed of the flywheel. The magnitude of the torque can be changed by adjusting the angular momentum magnitude. The angular momentum direction can be changed by adjusting the gimbal angle. The magnitude of the torque can be changed by adjusting the gimbal rate. The actuators 109 may encounter situations where it fails to generate the control torque due to hardware limits, such as, without limitations, the flywheel speed, gimbal angle range, or gimbal rate. Each actuator 109 may include one or more outer frames/rings, one or more inner frames/rings, three gimbal axes (pitch axis for tilt that permits the device 131 to tilt up or down, roll axis for roll that permits the device 131 to roll from side to side, yaw axis for pan that permits the device 131 to pan left or right), and one or more sensors, such as, without limitations, an Inertial Measurement Unit (IMU), an accelerometer, a gyroscope, a gimbal encoder, and a tachometer. The outer and inner frames/rings may interdependently rotate, with the outer frame serving as the reference point, and the inner frame directly holding the device 131 to be stabilized. The IMU may be configured to measure the velocity, acceleration, or rotation rate of the device 131. The actuators 109 may further include one or more gimbal encoders configured to measure the position of the actuators 109 and one or more tachometers configured to measure the rotation rate of flywheel of the actuators 109. The actuators 109 may be mechanically attached to the device 131 to counteract external forces or movements, allowing the stabilized device 131 to remain level and steady.

The CoG control system 100 may include the one or more motion sensors 107. The sensors 107 may include, without limitation, one or more of IMUs, accelerometers, gyroscopes, magnetometers, or a combination thereof. The motion sensors 107 may be mechanically coupled to the device 131. In some embodiments, the motion sensors 107 may be mechanically coupled to the simulator body 151. The motion sensors 107 may generate state information of the device 131 such as, without limitations, velocity, acceleration, attitude, and rotational rate of the device 131. The CoG control system 100 may include the weight sensor 111. The weight sensor 111 may be configured to measure the loading weight added to the device 131, such as the weight of a user 311.

The CoG control system 100 may include one or more processors 204. The processor may be included, without limitations, in the controller 201 (such as a computer, a laptop, a tablet, a smartphone, or a simulator equipment), the device 131, a server, or a third-party electronic device.

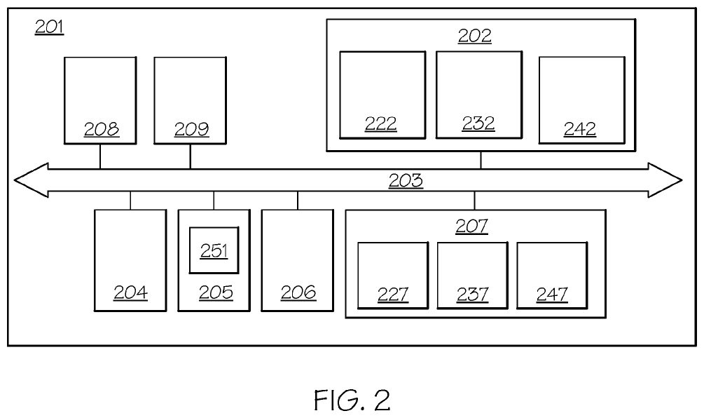

Referring to FIG. 2, example non-limiting components of the controller 201 are depicted. The CoG control system 100 may include a controller 201. The controller 201 may include various modules. For example, the controller 201 may include a sensing module 222, an actuation module 232, and a CoG estimation module 242. The controller 201 may further comprise various components, such as a memory component 202, a processor 204, an input/output hardware 205 including the user interface 251, a network interface hardware 206, a data storage component 207, and a local interface 203. The controller 201 may include a camera 208 and one or more other sensors 209.

The controller 201 may be any device or combination of components comprising a processor 204 and a memory component 202, such as a non-transitory computer-readable memory. The processor 204 may be any device capable of executing the machine-readable instruction set stored in the non-transitory computer-readable memory. Accordingly, the processor 204 may be an electric controller, an integrated circuit, a microchip, a computer, or any other computing device. The processor 204 may include any processing component(s) configured to receive and execute programming instructions (such as from the data storage component 207 and/or the memory component 202). The instructions may be in the form of a machine-readable instruction set stored in the data storage component 207 and/or the memory component 202. The processor 204 is communicatively coupled to the other components of the controller 201 by the local interface 203. Accordingly, the local interface 203 may communicatively couple any number of processors 204 with one another, and allow the components coupled to the local interface 203 to operate in a distributed computing environment. The local interface 203 may be implemented as a bus or other interface to facilitate communication among the components of the controller 201. In some embodiments, each of the components may operate as a node that may send and/or receive data. While the embodiment depicted in FIG. 2 includes a single processor 204, other embodiments may include more than one processor 204.

The memory component 202 (e.g., a non-transitory computer-readable memory component) may comprise RAM, ROM, flash memories, hard drives, or any non-transitory memory device capable of storing machine-readable instructions such that the machine-readable instructions can be accessed and executed by the processor 204. The machine-readable instruction set may comprise logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, etc., that may be compiled or assembled into machine readable instructions and stored in the memory component 202. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory component 202 may be a machine-readable memory (which may also be referred to as a non-transitory processor-readable memory or medium) that stores instructions that, when executed by the processor 204, causes the processor 204 to perform a method or control scheme as described herein. While the embodiment depicted in FIG. 2 includes a single non-transitory computer-readable memory component, other embodiments may include more than one memory module. The memory may be used to store the sensing module 222, the actuation module 232, and the CoG estimation module 242. Each of the sensing module 222, the actuation module 232, and the CoG estimation module 242 during operating may be in the form of operating systems, application program modules, and other program modules. Such program modules may include, but are not limited to, routines, subroutines, programs, objects, components, and data structures for performing specific tasks or executing specific abstract data types according to the present disclosure as will be described below.

The sensing module 222 may operably control the various sensors of the CoG control system 100 to receive sensory data, such as the camera 208, the weight sensor 111, the motion sensors 107, and the sensors of the actuators 109. The actuation module 232 may operably control the actuator 109 to supply the control torque to the device 131 and the weights 105 to move along one or more axes of the device 131. The CoG estimation module 242 may operably estimate the CoG of the device based on the sensory data. The actuation module 232 and the CoG estimation module 242 may include one or more algorithms for rotation control and CoG estimations. The one or more algorithms may be based on Artificial Intelligence (AI) techniques and is trained to allow the one or more algorithms to learn from prior control data or a range of sample CoG sensory data regarding the torque compensation and CoG adjustments to generate a variety of control signals. The one or more algorithms in the CoG estimation module 242 may be trained and provided with machine-learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in a field of machine learning, for example, is a class of deep, feed-forward ANNs applied for audio analysis of the recordings. CNNs may be shift or space invariant and utilize shared-weight architecture and translation.

The input/output hardware 205 may include a monitor, keyboard, mouse, printer, camera, microphone, speaker, and/or other device for receiving, sending, and/or presenting data. The input/output hardware 205 may further include one or more user interfaces 251 as described herein. The network interface hardware 206 may include any wired or wireless networking hardware, such as a modem, LAN port, Wi-Fi card, WiMax card, mobile communications hardware, and/or other hardware for communicating with other networks and/or devices. The data storage component 207 may store user information 227, historical CoG data 237, historical control data 247, the sensory data received from various sensors, operation data of the various sensors, actuators, gimbals, and the weights.

The controller 201 may include one or more cameras 208. Each of the camera 208 is coupled to the local interface 203 and communicatively coupled to the one or more processors 204. The one or more camera 208 may include a selection of, without limitations, a vision sensor, light detection and ranging (LIDAR) sensor, a thermal image sensor, an infrared sensor, an ultrasonic sensor, and/or a combination thereof. The camera 208 may be, without limitation, an RGB camera, a depth camera, an infrared camera, a wide-angle camera, or a stereoscopic camera. The one or more cameras 208 may be any device having an array of sensing devices capable of detecting radiation in an ultraviolet wavelength band, a visible light wavelength band, or an infrared wavelength band. The one or more cameras 208 may have any resolution. In some embodiments, one or more optical components, such as a mirror, fish-eye lens, or any other type of lens may be optically coupled to the one or more cameras 208. In embodiments, the one or more camera 208 may provide image data to the one or more processors 204 or another component communicatively coupled to the local interface 203.

The controller 201 may include one or more other sensors 209. The one or more other sensors 209 may include the motion sensors 107 and the weight sensor 111. Each of the one or more other sensors 209 is coupled to the local interface 203 and communicatively coupled to the one or more processors 204. The one or more other sensors 209 may include one or more motion sensors for detecting and measuring motion and changes in the motion of the device 131. The motion sensors may include inertial measurement units. Each of the one or more motion sensors may include one or more accelerometers and one or more gyroscopes. Each of the one or more motion sensors transforms the sensed physical movement of the device 131 into a signal indicative of an orientation, a rotation, a velocity, or an acceleration of the vehicle.

Referring to FIGS. 3A and 3B, the CoGs 301, 303 of an example device 131 before occupied (FIG. 3A) and after occupied (FIG. 3B) are depicted. In embodiments, the device 131 may be occupied by a user 311, such as a human, an animal, a robot, or another device or object. Before the user 311 occupies the device 131, the CoG 303 of the device 131 may be located at a point within the device, such as a geometric center of the device 131. The device 131 is in a balanced and stable state. In some embodiments, the CoG 303 of the unoccupied device 131 may be at or close to the rotation center of the device 131. The rotation center is the point about which is being rotated. For example, as illustrated in FIGS. 1 and 3A-4B, the simulator body 151 may be configured to rotate around the rotation point end 132. The rotation center of the device 131 may be the rotation point end 132. In embodiments, the rotation center may be at or close to the CoG 303 of the unoccupied device 131. Accordingly, the rotation center and the CoG 303 of the device 131 are aligned to render the device 131 stable and controllable.

After the user 311 occupies the device 131, the CoG 301 of the occupied device 131 may shift from the CoG 303 of the unoccupied device, while the rotation center may remain at the rotation point end 132. The shift of the CoG 301 may be a vector sum of the CoG 303 of the unoccupied device 131 and a CoG of the user 311. For example, as illustrated in FIG. 3B, after the user 311 sits on the device 131, the CoG 303 of the unoccupied device 131 located around the rotation point end 132 move upward to the CoG 301 of the device. Accordingly, the CoG 301 of the device may be off the rotation center of the device 131. In some embodiments, the rotation center of the device 131 may be the rotation point end 132. As described in detail further below, after the user 311 occupies the device 131, the CoG control system 100 may conduct a pre-operation process to determine an initial CoG based on the user 311's user information. After obtaining an initial CoG 301, the CoG control system 100 may manipulate the actuator 109 and collect sensory data of the device 131 using the various sensors of the CoG control system 100 to further generate an estimated CoG. The motion sensors 107, such as the IMU sensor, the accelerometer, the gyroscope, and the magnetometer, may measure state information of the device 131, including attitude, angular velocity, and angular acceleration of the device 131. In some embodiments, the CoG control system 100 may also manipulate one or more of the weights 105 to introduce additional controlled rotational motions to the device 131 and collect associated sensory data of the device 131 in determining the estimated CoG. The CoG control system 100 may use the CoG estimation module 242 to determine the estimated CoG.

Referring to FIGS. 4A and 4B, the CoG 301 of an example device 131 before CoG adjustment (FIG. 4A) and after CoG adjustment (FIG. 4B) is depicted. As illustrated in FIG. 4A, the CoG 301 of the occupied device 131 may be lifted from the CoG 303 (as in FIG. 3B) and deviate from the rotation center (e.g. the rotation point end 132). The lifted CoG 301 may render the device 131 more prone to tipping and become unstable. The deviation of the CoG 301 from the rotation center, such as the rotation point end 132, may introduce undesirable torque to the device 131 and may cause the device 131 to rotate. The CoG control system 100 may determine whether the induced instability or torque is beyond an acceptable threshold and manipulate the actuator 109 and/or the weights 105 accordingly to compensate for the torque.

In some embodiments, the CoG control system 100 may use actuators 109 to generate a control torque to compensate for undesirable torque and enhance the stability of the device 131. The CoG control system 100 may calculate the undesirable torque based on the sensory data generated by the motion sensors 107 (such as the one or more other sensors 209 including the IMU, accelerometers, and gyroscopes). The CoG control system 100 may calculate the control torque based on the undesirable torque and control the actuators 109 to generate the control torque based on the angle and angular velocity of the actuators 109. To control the actuators 109, the CoG control system 100 may monitor the actuators 109 by using the gimbal encoders and tachometers to measure the angle and angular velocity of the actuators 109.

In some embodiments, the CoG control system 100 may move the weights 105 to manipulate the CoG 301 of the device 131 to arrive at a target CoG. In some embodiments, the target CoG may be the CoG 303 of the unoccupied device 131, at the position of the rotation center (e.g. the rotation point end 132), or at a position close to the rotation center to create an assistant torque to counteract the undesirable torque. After the weights 105 move from the position 405 of weights before adjustment, the CoG control system 100 may monitor whether the CoG 301 moves from the lifted or deviated CoG 301 to a position of CoG 403 at or close to the target CoG such that the difference between the CoG 403 and the target CoG is less than or equal to a threshold CoG deviation. The threshold CoG deviation may be a preset value based on the structure of the device 131, the rotation center, the maximum control torque of the device that may be introduced by the actuator 109. When the CoG 403 is at or around the target CoG within the threshold CoG deviation of the target CoG, the CoG control system 100 may determine that the device 131 is sufficiently balanced for its intended operation, ensuring stability and target performance of the device 131. The system 100 may have a real-time training process to train the AI-based algorithm in the CoG estimation module 242 based on the weight movement, the CoG 301 of the device, and the state information of the device 131.

In some embodiments, the CoG control system 100 may use both the actuators 109 and the weights 105 to manage the undesirable torque, and move the weights 105 to offset any uncompensated torque resulting from the control torque generated by the actuators 109. In some embodiments, the uncompensated torque may be due to the limitation of the actuators 109, such as a gimbal singularity state, finite range of motion of the actuators 109, or a limited torque capacity of the actuators 109. In some embodiments, the CoG control system 100 may use the weights 105 to partially compensate the torque to improve actuators 109 usage, reduce power consumption, or safeguard the actuators 109 against excessive wear and overuse. The CoG control system 100 may determine an assistant torque to offset any uncompensated torque by the actuators 109 and determine the target CoG based on the assistant torque, the gravity of the occupied device, and/or the position of the target CoG relative to the rotation center. The CoG control system 100 may operate the actuators 109 to generate a control torque and further move the weights 105 to manipulate the CoG 301 of the occupied device 131 to substantially compensate any undesirable torque.

In some embodiments, the CoG control system 100 may receive input from the user 311 through the user interface 251 (e.g. the foot panel 155, the simulator wheel 157, or the simulator joystick) to manipulate the motion of the device 131. The system 100 may determine a demand torque based on the user input of the motion manipulation. The system 100 may operate the actuators 109 to generate the control torque to drive the device 131 based on the demand torque. In some embodiments, the system 100 may move the weights 105 to generate the assistant torque to drive the device 131 based on the demand torque and the control torque. For example, the system 100 may monitor the motion state of the actuator 109 in terms of whether the demand torque is beyond the control torque limitation of the actuator 109. In response to determining that the demand torque is within the control torque limitation of the actuator 105, the system 100 may move the weights 105 to render the CoG of the device 131 at the rotation center (such as the rotation point end 132) of the device 131, and use the actuator 109 to generate the control torque to change the attitude of the device 131 based on the user input from the user interface 251. Alternatively, in determining that the demand control torque is or is about to be beyond the control torque limitation of the actuator 109, the system 100 may move the weight to generate an assistant torque along with the control torque generated by the actuator 109 to generate the demand torque based on the user input from the user interface 251 (e.g. the simulator wheel 157).

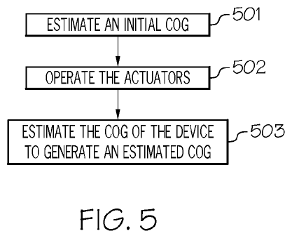

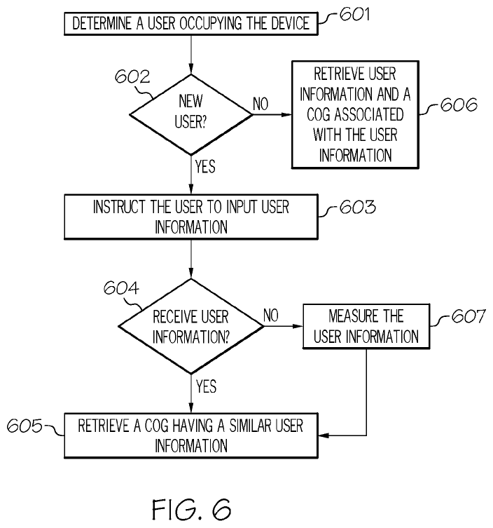

Referring to FIGS. 5 and 6, a flow diagram of the pre-operation process using the CoG control system 100 is illustrated. At block 501, the CoG control system 100 may determine the user 311 occupies the device 131 and estimate an initial CoG. The process of obtaining the initial CoG information is depicted in FIG. 6. At block 502, after obtaining the initial CoG 301, the actuation module 232 may operate the actuator 109, and the sensing module 222 may collect operation data of the actuator 109 and the weights 105, and collect the sensory data using the motion sensors 107 during the process. For example, the actuation module 232 may operate the actuator 109 in a controlled manner to generate controlled control torque. The sensing module 222 may use the motion sensors 107, such as the IMU sensor, the accelerometer, the gyroscope, and the magnetometer, to collect the state information of the device 131, including attitude, angular velocity, and angular acceleration of the device 131. At block 503, the CoG estimation module 242 may use a trained AI-based algorithm to generate an estimated CoG based on the state information. In some embodiments, during the pre-operation process, the CoG estimation module 242 may generate the estimated CoG further based on the actuator operation information, such as the angle of the actuators 109 and the angular velocity of the actuators 109 measured using gimbal encoders and tachometers.

In some embodiments, after the pre-operation process, the CoG control system 100 may obtain constant and stable CoG parameters in three-axis directions. In other embodiments, the, after the pre-operation process, the CoG parameters in three-axis directions may vary due the movement of the user and the system 100 may continuously estimate the CoG of the device 131.

In some embodiments, the CoG parameter may be the product of the weight of the user 311 and the CoG deviation from the target CoG. The target CoG may be the rotation center or the CoG of unoccupied device 131.

Referring to FIG. 6, the initial CoG determination as in block 501 of FIG. 5 is depicted. At block 601, the CoG control system 100 may determine the user 311 occupies the device 131. The CoG control system 100 may use the camera 208 or the weight sensor 111 to determine whether the device 131 is occupied. At block 602, the CoG control system 100 may determine whether the user 311 is a new user or a returning user. In response to determining that the user 311 is a returning user (no to block 602), at block 606, the CoG control system 100 may retrieve user information of the user 311 and further retrieve the initial CoG associated with the user 311. The user information of a user may include the user 311's identification, height, weight, and dimensional information.

In response to determining that the user 311 is a new user (yes to block 602), at block 603, the CoG control system 100 may instruct the user 311 to input user information at the user interface 251. At block 604, the CoG control system 100 may determine whether the user 311 input the user information and the CoG control system 100 receives the user information. In response to determining that the CoG control system 100 does not receive any user information from the user 311 as a new user (no to block 604), at block 607, the CoG control system 100 may measure partial user information of the user 311, such as identification, height, and weight, using the camera 208 and the weight sensor 111.

At block 605, after receiving user information from stored user information 227 in the data storage component 207 at 604 (yes to block 604) or after measuring user information at block 607, the CoG control system 100 may retrieve a CoG associated with a comparable user as the initial CoG. The user information of the comparable user may have a difference below a mass distribution threshold compared with the user information of the user 311. The mass distribution threshold may be determined based on the height and weight of the user 311. In some embodiments, when there is no comparable user available in the CoG control system 100, such as the weight or height of available user information are not comparable to the user 311, the CoG control system 100 may provide a preset initial CoG based on average weight and height information. After the pre-operation process, the CoG control system 100 may store the estimated CoG associated with the user 311 and update the historical CoG data 237 in the profile associated with the user 311 in the data storage component 207. The historical CoG data 237 may be retrieved for the initial state information.

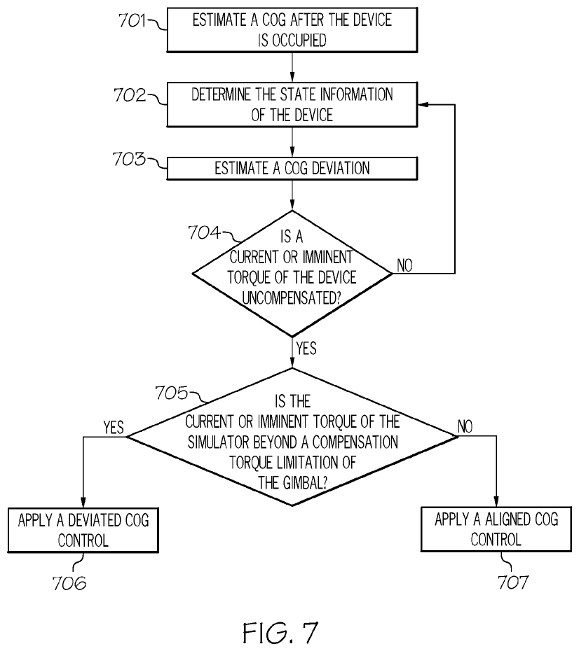

Referring to FIG. 7, a flow diagram of dynamic CoG adjustment using the CoG control system is depicted. At block 701, the CoG control system 100 may estimate the CoG of the device 131 after the device is occupied by a user 311. The CoG control system 100 may estimate the CoG of the device 131 based on the state information of the device 131.

At block 702, the CoG control system 100 may continuously determine the state information of the device 131, such as the state information and the operation data of the device 131. The sensing module 222 may operate the motion sensors 107 to collect state information, such as the velocity, acceleration, attitude, rotational rate, and/or external torque of the device. The actuation module 232 may collect operation data of the device 131 and the actuators 109, such as the control torque induced by the actuators 109.

At block 703, the CoG estimation module 242 may determine the CoG of the device 131 and compared with the target CoG of the device 131 to estimate the CoG deviation. At block 704, the CoG control system 100 may determine whether the current torque of the device 131 is uncompensated or whether an imminent torque of the device 131 will be uncompensated. For an answer no to the block 704, at block 702, the CoG control system 100 continue to monitor the state information of the device 131.

If the answer to the block 704 is a yes, at block 705, the CoG control system 100 further determines whether the current torque of the device 131 or the imminent torque of the device 131 may be not compensated by the actuators 109 because a predicted compensation torque is beyond the limitation of the actuators 109. The imminent torque may refer to a predicted torque at a frame of time in which the system 100 may respond to compensate. A time may be imminent within a matter of seconds, milliseconds, or other short period of time. The imminent torque may be predicted based on the current torque and a sequence of previous torque measured in the past short of period. In some embodiments, the imminent torque is predicted for the torque value within 0.001, 0.002 s, 0.005 s, 0.008 s, 0.01 s, 0.02 s, 0.05 s, 0.08 s, 0.1 s, 0.2 s, 0.3 s, 0.5 s, 0.8 s, 1 s, 2 s, 3 s, 5 s, 8 s, 10 s, 20 s, 30 s, 50 s, 1 min, 2 min, 5 min, or any period of time between 0.01 s and 5 min. The torque is substantially compensated by the control torque generated by the actuators 109 when the amplitude of the control torque is substantially the same as the amplitude of the current or imminent torque of the device 131 and the direction of the control torque is substantially opposite to the direction of the current or imminent torque of the device 131. Due to the limitation of the actuators 109, such as an imminent singularity state of the actuators 109, the actuators 109 may not generate the control torque sufficiently compensating for the current or imminent torque of the device 131, or the demand torque requested from the user 311.

In response to determining that the compensation torque or the demand torque is beyond the limitation of the actuators 109, at block 706, the CoG control system 100 may apply a deviated CoG control. The CoG control system 100 may move the weights 105 to manipulate the CoG of the device 131 to or close to the target CoG within the threshold CoG deviation. The target CoG may be at or close to the rotation center. In some embodiments, after the moving of the weights 105, the CoG deviation between the CoG of the device 131 and the target CoG may be less than or equal to the threshold CoG deviation. In some embodiments, after the moving of the weights 105, the imminent torque or the demand torque is less than or equal to the control torque limitation of the actuator 109. In some other embodiments, after the moving of the weights 105, the imminent torque or the demand torque is less than or equal to a sum of the assistant torque and the control torque, wherein the control torque is less than or equal to the control torque limitation of the actuator 109. The movement of the weights 105 may be determined based on the state information of the device 131, the operation data of the device 131 and the actuators 109, and/or the likelihood of singularity state of the actuators 109 based on the direction and angular speed of the actuators 109. Accordingly, the movement of weights 105 may avoid or delay the singularity state of the actuators 109, and reduce the current or imminent torque of the device 131 to less than or equal to the control torque limitation of the actuators 109. The control torque limitation of the actuator 109 may be determined based on the likelihood of the singularity, range of motion, and torque capacity of the actuator 109. A time may be imminent within a matter of seconds, milliseconds, or other short period of time. In some embodiments, the imminent torque is predicted for the torque value within 0.001, 0.002 s, 0.005 s, 0.008 s, 0.01 s, 0.02 s, 0.05 s, 0.08 s, 0.1 s, 0.2 s, 0.3 s, 0.5 s, 0.8 s, 1 s, 2 s, 3 s, 5 s, 8 s, 10 s, 20 s, 30 s, 50s, 1 min, 2 min, 5 min, or any period of time between 0.01 s and 5 min.

In response to determining that the compensation torque or the demand torque is not beyond the limitation of the actuators 109, at block 707, the CoG control system 100 may apply an aligned CoG control. The CoG control system 100 may move the weights 105 to manipulate the CoG of the device to or close to the target CoG, such as the rotation center, and reduce the CoG deviation between the CoG of the device 131 and the target CoG to less than or equal to the threshold CoG deviation. In some embodiments, the target CoG is the rotation center (e.g. the rotation end point 132) and the CoG of the device 131 may compensate the torque generated by the gravity of the device 131, or partially compensate the undesirable torque of the device 131. The movement of the weights 105 may be determined based on the state information of the device 131 and the operation data of the device 131. Accordingly, the movement of weights 105 may allow the actuators 109 to achieve feasible and desirable control of the device 131.

After the deviated CoG control at block 706 or the aligned CoG control at block 707, the CoG parameter (such as the product of the weight of the user 311 and the deviation CoG) reduces to a value below a threshold CoG deviation. In some embodiments, the threshold CoG deviation may be less than 10 g m, 8 g m, 6 g m, 4 g m, 2 g m, 1 g m, 0.8 g m, 0.6 g m, 0.4 g m, 0.2 g m, 0.1 g m, 0.08 g m, 0.06 g m, 0.04 g m, 0.02 g m, 0.01 g m, or any number below 10 g m in all three axis directions.

During the operation, the state information of the device 131 (such as attitude and angular rate), the state information of the actuators 109 (such as direction, angular velocity), and the control torque generated by the actuators 109 and the moving of weights 105, and dynamically estimated state information are stored in the historical CoG data 237 and the historical control data 247 of the data storage component 207.

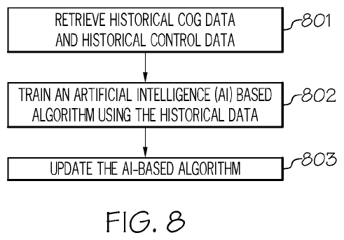

Referring to FIG. 8, a flow diagram of the retraining process using the CoG control system 100 is depicted. At block 801, the CoG control system 100 may retrieve historical CoG data 237 and historical control data 247 from the data storage. At block 802, the CoG control system 100 may train the AI-based algorithms in the actuating module 232 and the CoG estimation module 242 using the historical CoG data 237 and historical control data 247. At block 803, after training, the CoG control system 100 may update the AI-based algorithms.

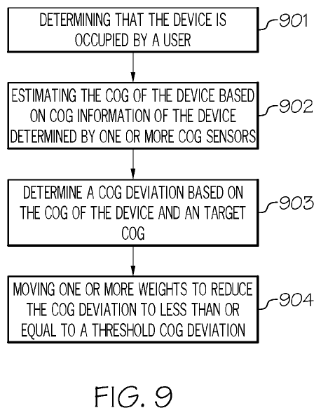

Referring to FIG. 9, a flow diagram of the method for CoG control is depicted. At block 901, the method for CoG control includes determining that the device 131 is occupied by a user 311. At block 902, the method for CoG control includes estimating the CoG 301 of the device 131 based on the state information of the device 131. At block 903, the method for CoG control includes determining a CoG deviation based on the CoG 301 of the device 131 and a target CoG. At block 904, the method for CoG control includes moving the weights to reduce the CoG deviation to less than or equal to a threshold CoG deviation.

In some embodiments, the motion sensors 107 may include, without limitations, one or more of accelerometers, gyroscopes, magnetometers, an inertial measurement unit (IMU), or a combination thereof, and the state information may include, without limitations, velocity of the device, acceleration of the device, attitude of the device, rotational rate of the device, torque of the device, or a combination thereof. The target CoG may be a CoG 303 (as in FIG. 3A) of the device 131 not occupied by the user 311, a rotation center of the device 131, or a position of CoG 403 (as in FIG. 4B) around the rotation center to generate an assistant torque.

In some embodiments, the method for CoG control may further include estimating an initial CoG of the device 131, generating, using the actuators 109, a control torque of the device 131, and estimating the CoG 301 of the device 131 based on the state information, the initial CoG of the device, the control torque of the device 131, the state information of the device 131, and/or state information of the actuators 109 determined based on data generated by motion sensors, one or more gimbal encoders, tachometers, or a combination thereof.

In some embodiments, the method for CoG control may further include determining whether the user 311 is a new user or a returning user, in response to determining that the user 311 is a new user, determining user information of the new user by measuring, using the camera 208 and the weight sensor 111, the user information, or by receiving input of the user information from the new user, and retrieving the initial CoG associated with a comparable user, wherein user information difference between the new user and the comparable user is below a mass distribution threshold, and in response to determining that the user 311 is a returning user, retrieving the initial CoG associated with the returning user.

In some embodiments, the method for CoG control may further include determining a change of the CoG 301 of the device 131 based on the State information, the initial CoG, an updated control torque, and an updated state information of the device, and updating the CoG 301 of the device 131.

In some embodiments, the method for CoG control may further include using one or more actuators 109 that are mechanically attached to the device 131 to generating control torque to substantially compensate for a torque of the device 131 by adjusting angular velocities of the gimbals in the actuators 109 (e.g. the angular velocities of the gimbals of the CMGs in the actuators 109) or magnitudes of angular momentum of the flywheels in the actuators 109 (e.g. the magnitudes of angular momentum of reaction wheels of the actuators 109). The control torque substantially compensating for the torque of the device 131 may include an amplitude substantially the same as the amplitude of the torque of the device 131 and a direction substantially opposite to the direction of the torque of the device 131.

In some embodiments, the method for CoG control may further include determine whether an imminent torque or a demand torque of the device is beyond a control torque limitation of the actuator 109, in response to determining that the imminent torque or the demand torque of the device 131 is beyond the control torque limitation of the actuator 109, set the target CoG as a point around the rotation center to generate an assistant torque such that the imminent torque or the demand torque is less than or equal to a sum of the assistant torque and the control torque less than or equal to the control torque limitation of the actuator 109, and in response to determining that the imminent torque or the demand torque of the device 131 is less than or equal to the control torque limitation of the actuator 109, set the target CoG as a rotation center of the device 131.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including matters of logic with respect to the arrangement of steps, operational flow, order of components, or orientation of components; plain meaning derived from grammatical organization or punctuation, and; the number or type of embodiments described in the specification.

While particular embodiments have been illustrated and described herein, it may be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

Further aspects of the embodiments described herein are provided by the subject matter of the following numbered clauses:
1. A system for controlling a center of gravity (CoG) of a device, the system comprising:
   one or more weights mechanically coupled to the device and operable to move along one or more body axes of the device;
   one or more motion sensors configured to determine state information of the device; and
   one or more processor operable to:
   determine that the device is occupied by a user;
   estimate the CoG of the device based on the state information of the device;
   determine a CoG deviation based on the CoG of the device and a target CoG; and
   move the weights to reduce the CoG deviation to less than or equal to a threshold CoG deviation.
2. The system according to clause 1, wherein the motion sensors comprise one or more of accelerometers, gyroscopes, magnetometers, an inertial measurement unit (IMU), or a combination thereof, and the state information comprises velocity of the device, acceleration of the device, attitude of the device, rotational rate of the device, or a combination thereof.
3. The system according to any previous clause, wherein the target CoG is a CoG of the device not occupied by the user, a rotation center of the device, or a point around the rotation center to generate an assistant torque.
4. The system according to any previous clause, further comprising one or more actuators, wherein the estimation of the CoG of the device comprises:
   estimating an initial CoG of the device;
   generating, using the actuators, a control torque of the device; and
   estimating the CoG of the device based on the initial CoG of the device, the control torque, and the state information of the device.
5. The system according to clause 4, wherein the actuators comprise one or more gimbals, one or more flywheels, or a combination thereof, and the state information of the device further comprises state information of the actuators determined based on data generated by a gimbal encoder, a tachometer, or a combination thereof.
6. The system according to any of clause 4 and clause 5, further comprising a camera and a weight sensor, wherein the estimation of the initial CoG of the device comprises:
   determining whether the user is a new user or a returning user;
   in response to determining that the user is a new user, determining user information of the new user by measuring, using the camera and the weight sensor, the user information, or by receiving input of the user information from the new user, and retrieving the initial CoG associated with a comparable user, wherein user information difference between the new user and the comparable user is below a mass distribution threshold; or
   in response to determining that the user is a returning user, retrieving the initial CoG associated with the returning user.
7. The system according to any of clauses 4-6, wherein the estimation of the CoG of the device further comprises:
   determining a change of the CoG of the device based on the state information, the initial CoG, an updated control torque, and an updated state information of the device; and
   updating the CoG of the device.
8. The system according to any of clauses 4-7, wherein the actuators comprise one or more gimbals mechanically attached to the device and operably generating the control torque to substantially compensate for a torque of the device by adjusting angular velocities of the gimbals or magnitudes of angular momentum of the flywheels.
9. The system according to any of clauses 4-8, wherein the control torque substantially compensating for the torque of the device comprises an amplitude substantially the same as the amplitude of the torque of the device and a direction substantially opposite to the direction of the torque of the device.
10. The system according any of clauses 4-9, wherein the processors are further operable to:
   determine whether an imminent torque or a demand torque of the device is beyond a control torque limitation of the actuators, in response to determining that the imminent torque or the demand torque of the device is beyond the control torque limitation of the actuators, set the target CoG as a point around the rotation center to generate an assistant torque such that the imminent torque or the demand torque is less than or equal to or a sum of the assistant torque and the control torque, wherein the control torque is less than or equal to the control torque limitation of the actuators; and
   in response to determining that the imminent torque or the demand torque of the device is less than or equal to the control torque limitation of the actuators, set the target CoG as a rotation center of the device.
11. The system according to any of clauses 4-10, wherein the control torque limitation of the actuators comprises a singularity state, and the actuators in the singularity state lose one or more degrees of freedom due to limitations of rotational angles or rotational velocity.
12. A simulator comprising:
   a simulator pillar having a base end and a rotation point end;
   a simulator body rotatably coupled to the pillar at the rotation point end, the simulator body configured to be occupied by a user;
   a simulator base mechanically coupled to the pillar at the base end;
   one or more actuators configured to move the simulator body to generate a control torque of the simulator, wherein the actuators comprise one or more gimbals, one or more flywheels, or a combination thereof mechanically attached to the simulator body and operably generating the control torque to substantially compensate for a torque of the simulator body by adjusting angular velocities of the gimbals or magnitudes of angular momentum of the flywheels;
   one or more weights mechanically coupled to the simulator and operable to move along one or more body axes of the simulator;
   one or more motion sensors configured to determine Center of Gravity (CoG) information of the simulator, wherein the motion sensors comprise one or more of accelerometers, gyroscopes, magnetometers, an inertial measurement unit (IMU), or a combination thereof; and
   one or more processors operable to:
      determine that the simulator is occupied by the user;
      estimate the CoG of the simulator based on the state information of the simulator;
      determine a CoG deviation based on the CoG of the simulator and a target CoG, wherein the target CoG is a CoG of the simulator body without occupancy by the user, a rotation center of the simulator, or a point around the rotation center to generate an assistant torque; and
      move the weights to reduce the CoG deviation to less than or equal to a threshold CoG deviation.
13. The simulator according to clause 12, wherein the simulator body comprises a simulator seat, a simulator foot panel, a simulator wheel, and a simulator joystick.
14. The simulator according to any of clause 12 and clause 13, wherein the estimation of the CoG of the simulator comprises:
   estimating an initial CoG of the simulator based on user information of the user;
   generating, using the actuators, the control torque of the simulator; and
   estimating the CoG of the simulator based on the state information, the initial CoG of the simulator, the control torque, and the state information of the simulator.
15. The simulator according to any of clauses 12-14, wherein the processors are further operable to:
   determine whether an imminent torque or a demand torque of the simulator is beyond a control torque limitation of the actuators,
   in response to determining that the imminent torque or the demand torque of the simulator is beyond the control torque limitation of the actuators, set the target CoG as the point around the rotation center of the simulator to generate an assistant torque such that the imminent torque or the demand torque is less than or equal to or a sum of the assistant torque and the control torque, wherein the control torque is less than or equal to the control torque limitation of the actuators; and
   vin response to determining that the imminent torque or the demand torque of the simulator is less than or equal to the control torque limitation of the gimbal, set the target CoG as a rotation center of the simulator.
16. A method for controlling a center of gravity (CoG) of a device comprising:
   determining that the device is occupied by a user;
   estimating the CoG of the device based on state information of the device determined by one or more motion sensors;
   determining a CoG deviation based on the CoG of the device and a target CoG, wherein the target CoG is a CoG of the device not occupied by the user, a rotation center of the device, or a point around the rotation center to generate an assistant torque; and
   moving one or more weights to reduce the CoG deviation to less than or equal to a threshold CoG deviation, wherein the one or more weights are mechanically coupled to the device and operable to move along one or more body axes of the device.
17. The method according to clause 16, wherein the motion sensors comprise one or more of accelerometers, gyroscopes, magnetometers, or a combination thereof, and the state information comprises velocity of the device, acceleration of the device, attitude of the device, rotational rate of the device, or a combination thereof.
18. The method according to any of clause 16 and clause 17, wherein the method further comprises:
   estimating an initial CoG of the device based on user information of the user;
   generating, using one or more actuators, a control torque of the device;
   estimating the CoG of the device based on the state information, the initial CoG of the device, the control torque, and the state information of the device;
   determining a change of the CoG of the device based on the state information, the initial CoG, an updated control torque, and an updated state information of the device; and
   updating the CoG of the device.
19. The method according to any of clauses 16-18, wherein the method further comprises:
   Generating, using one or more gimbals and/or one or more flywheels mechanically attached to the device, control torque to substantially compensate for a torque of the device by adjusting angular velocities of the gimbals or magnitudes of angular momentum of the flywheels,
   determining whether an imminent torque or a demand torque of the device is beyond a control torque limitation of the actuators,
   in response to determining that the imminent torque or the demand torque of the device is beyond the control torque limitation of the actuators, setting the target CoG as the point around the rotation center to generate an assistant torque such that the imminent torque or the demand torque is less than or equal to or a sum of the assistant torque and the control torque, wherein the control torque is less than or equal to the control torque limitation of the actuators; and
   in response to determining that the imminent torque or the demand torque of the device is less than or equal to the control torque limitation of the gimbal, setting the target CoG as a rotation center of the device.
20. The method according clause 19, wherein the control torque limitation of the actuators comprises a singularity state, and the actuators in the singularity state lose one or more degrees of freedom due to limitations of rotational angles or rotational velocity.

1. A system for controlling a center of gravity (CoG) of a device, the system comprising:
one or more weights mechanically coupled to the device and operable to move along one or more body axes of the device;
one or more motion sensors configured to determine state information of the device; and
one or more processors operable to:
determine that the device is occupied by a user;
estimate the CoG of the device based on the state information of the device;
determine a CoG deviation based on the CoG of the device and a target CoG; and
move the weights to reduce the CoG deviation to less than or equal to a threshold CoG deviation.

2. The system of claim 1, wherein the motion sensors comprise one or more of accelerometers, gyroscopes, magnetometers, an inertial measurement unit (IMU), or a combination thereof, and the state information comprises velocity of the device, acceleration of the device, attitude of the device, rotational rate of the device, or a combination thereof.

3. The system of claim 1, wherein the target CoG is a CoG of the device not occupied by the user, a rotation center of the device, or a point around the rotation center to generate an assistant torque.

4. The system of claim 1, further comprising one or more actuators, wherein the estimation of the CoG of the device comprises:
estimating an initial CoG of the device;
generating, using the actuators, a control torque of the device; and
estimating the CoG of the device based on the initial CoG of the device, the control torque, and the state information of the device.

5. The system of claim 4, wherein the actuators comprise one or more gimbals, one or more flywheels, or a combination thereof, and the state information of the device further comprises state information of the actuators determined based on data generated by a gimbal encoder, a tachometer, or a combination thereof.

6. The system of claim 4, further comprising a camera and a weight sensor, wherein the estimation of the initial CoG of the device comprises:
determining whether the user is a new user or a returning user;
in response to determining that the user is a new user, determining user information of the new user by measuring, using the camera and the weight sensor, the user information, or by receiving input of the user information from the new user, and retrieving the initial CoG associated with a comparable user, wherein user information difference between the new user and the comparable user is below a mass distribution threshold; or
in response to determining that the user is a returning user, retrieving the initial CoG associated with the returning user.

7. The system of claim 4, wherein the estimation of the CoG of the device further comprises:
determining a change of the CoG of the device based on the state information, the initial CoG, an updated control torque, and an updated state information of the device; and
updating the CoG of the device.

8. The system of claim 4, wherein the actuators comprise one or more gimbals mechanically attached to the device and operably generating the control torque to substantially compensate for a torque of the device by adjusting angular velocities of the gimbals or magnitudes of angular momentum of the flywheels.

9. The system of claim 8, wherein the control torque substantially compensating for the torque of the device comprises an amplitude substantially the same as the amplitude of the torque of the device and a direction substantially opposite to the direction of the torque of the device.

10. The system of claim 8, wherein the processors are further operable to:
determine whether an imminent torque or a demand torque of the device is beyond a control torque limitation of the actuators,
in response to determining that the imminent torque or the demand torque of the device is beyond the control torque limitation of the actuators, set the target CoG as a point around a rotation center to generate an assistant torque such that the imminent torque or the demand torque is less than or equal to or a sum of the assistant torque and the control torque, wherein the control torque is less than or equal to the control torque limitation of the gimbal; and
in response to determining that the imminent torque or the demand torque of the device is less than or equal to the control torque limitation of the actuators, set the target CoG as the rotation center of the device.

11. The system of claim 10, wherein the control torque limitation of the actuators comprises a singularity state, and the actuators in the singularity state lose one or more degrees of freedom due to limitations of rotational angles or rotational velocity.

12. A simulator comprising:
a simulator pillar having a base end and a rotation point end;
a simulator body rotatably coupled to the pillar at the rotation point end, the simulator body configured to be occupied by a user;
a simulator base mechanically coupled to the pillar at the base end;
one or more actuators configured to move the simulator body to generate a control torque of the simulator, wherein the actuators comprise one or more of gimbals, flywheels, or a combination thereof mechanically attached to the simulator body and operably generating the control torque to substantially compensate for a torque of the simulator body by adjusting angular velocities of the gimbals or magnitudes of angular momentum of the flywheels;
one or more weights mechanically coupled to the simulator and operable to move along one or more body axes of the simulator;
one or more motion sensors configured to determine Center of Gravity (CoG) information of the simulator, wherein the motion sensors comprise one or more of accelerometers, gyroscopes, magnetometers, an inertial measurement unit (IMU), or a combination thereof; and
one or more processors operable to:
determine that the simulator is occupied by the user;
estimate the CoG of the simulator based on state information of the simulator;
determine a CoG deviation based on the CoG of the simulator and a target CoG, wherein the target CoG is a CoG of the simulator body without occupancy by the user, a rotation center of the simulator, or a point around the rotation center to generate an assistant torque; and
move the weights to reduce the CoG deviation to less than or equal to a threshold CoG deviation.

13. The simulator of claim 12, wherein the simulator body comprises a simulator seat, a simulator foot panel, a simulator wheel, and a simulator joystick.

14. The simulator of claim 12, wherein the estimation of the CoG of the simulator comprises:
estimating an initial CoG of the simulator based on user information of the user;
generating, using the actuators, the control torque of the simulator; and
estimating the CoG of the simulator based on the initial CoG of the simulator, the control torque, and the state information of the simulator.

15. The simulator of claim 12, wherein the processors are further operable to:
determine whether an imminent torque or a demand torque of the simulator is beyond a control torque limitation of the actuators,
in response to determining that the imminent torque or the demand torque of the simulator is beyond the control torque limitation of the actuators, set the target CoG as the point around the rotation center of the simulator to generate the assistant torque such that the imminent torque or the demand torque is less than or equal to or a sum of the assistant torque and the control torque, wherein the control torque is less than or equal to the control torque limitation of the actuators; and
in response to determining that the imminent torque or the demand torque of the simulator is less than or equal to the control torque limitation of the gimbal, set the target CoG as the rotation center of the simulator.

16. A method for controlling a center of gravity (CoG) of a device comprising:
determining that the device is occupied by a user;
estimating the CoG of the device based on state information of the device determined by one or more motion sensors;
determining a CoG deviation based on the CoG of the device and a target CoG, wherein the target CoG is a CoG of the device not occupied by the user, a rotation center of the device, or a point around the rotation center to generate an assistant torque; and
moving one or more weights to reduce the CoG deviation to less than or equal to a threshold CoG deviation, wherein the one or more weights are mechanically coupled to the device and operable to move along one or more body axes of the device.

17. The method of claim 16, wherein the motion sensors comprise one or more of accelerometers, gyroscopes, magnetometers, or a combination thereof, and the state information comprises velocity of the device, acceleration of the device, attitude of the device, rotational rate of the device, or a combination thereof.

18. The method of claim 16, wherein the method further comprises:
estimating an initial CoG of the device based on user information of the user;
generating, using one or more actuators, a control torque of the device;
estimating the CoG of the device based on the initial CoG of the device, the control torque, and the state information of the device;
determining a change of the CoG of the device based on the state information, the initial CoG, an updated control torque, and an updated state information of the device; and
updating the CoG of the device.

19. The method of claim 16, wherein the method further comprises:
generating, using one or more gimbals and/or one or more flywheels mechanically attached to the device, a control torque to substantially compensate for a torque of the device by adjusting angular velocities of the gimbals or magnitudes of angular momentum of the flywheels,
determining whether an imminent torque or a demand torque of the device is beyond a control torque limitation of the actuators,
in response to determining that the imminent torque or the demand torque of the device is beyond the control torque limitation of the actuators, setting the target CoG as the point around the rotation center to generate the assistant torque such that the imminent torque or the demand torque is less than or equal to or a sum of the assistant torque and the control torque, wherein the control torque is less than or equal to the control torque limitation of the actuators; and
in response to determining that the imminent torque or the demand torque of the device is less than or equal to the control torque limitation of the gimbal, setting the target CoG as the rotation center of the device.

20. The method of claim 19, wherein the control torque limitation of the actuators comprises a singularity state, and the actuators in the singularity state lose one or more degrees of freedom due to limitations of rotational angles or rotational velocity.
